(19) United States
(12) Patent Application Publication
(10) Pub. No.: US 2014/0176577 A1
(43) Pub. Date: Jun. 26, 2014

(54) METHOD AND MECHANISM FOR PREEMPTING CONTROL OF A GRAPHICS PIPELINE

(71) Applicant: NVIDIA CORPORATION, Santa Clara, CA (US)

(72) Inventor: Albert Meixner, Mountain View, CA (US)

(73) Assignee: NVIDIA CORPORATION, Santa Clara, CA (US)

(21) Appl. No.: 13/722,771

(22) Filed: Dec. 20, 2012

(51) Int. Cl. G06T 1/20

(52) U.S. Cl. CPC G06T 1/20
USPC 345/506

(57) ABSTRACT

A method of operating a graphics pipeline, a graphics processing unit and a GPU computing system are provided by this disclosure. In one embodiment, the graphics processing unit includes: (1) a processor configured to assist in operating the graphics processing unit and (2) a graphics pipeline coupled to the processor and including a programmable shader stage, the programmable shader stage configured to determine occurrence of a pipeline exception during execution of the graphics pipeline, initiate preempting the execution in response to determining the occurrence and initiate resolving the pipeline exception before execution is restarted.

### TECHNICAL FIELD

This application is directed, in general, to graphics processing units (GPUs) and, more specifically, to operating graphic pipelines of a GPU.

### BACKGROUND

Computer processing using a GPU and a central processing unit (CPU) enables improved application performance by using the GPU for compute-intensive portions of an application while the remainder of the application code can run on a central processing unit (CPU). A computing system that uses the combination of a CPU and a GPU for processing, therefore, advantageously employs the CPU cores that are optimized for serial processing and the GPU cores that are efficiently designed for parallel processing. As such, serial code portions can run on the CPU while parallel code portions can run on the GPU.

Typically, the CPU generates work and sends the work to the GPU for processing. The GPU receives the work, completes the work, and informs the CPU that the work is completed. In a conventional GPU, fixed function units are connected together to form a graphics pipeline. The fixed function graphics pipeline processes the work from the CPU via a command buffer until the work is completed or there is an external request to switch context.

### SUMMARY

In one aspect, the disclosure provides a graphics processing unit. In one embodiment, the graphics processing unit includes: (1) a processor configured to assist in operating the graphics processing unit and (2) a graphics pipeline coupled to the processor and including a programmable shader stage, the programmable shader stage configured to determine occurrence of a pipeline exception during execution of the graphics pipeline, initiate preempting the execution in response to determining the occurrence and initiate resolving the pipeline exception before execution is restarted.

In another aspect, a method of operating a graphics pipeline of a graphics processing unit is disclosed. In one embodiment, the method includes: (1) receiving work at the graphics processing unit from a central processing unit associated therewith to be completed by the graphics pipeline, (2) processing the work along the graphics pipeline, (3) preempting the processing before completion of the work when determining occurrence of a pipeline exception, (4) resolving the pipeline exception and (5) restarting the processing.

In yet another aspect, a GPU computing system is disclosed. In one embodiment, the GPU computing system includes: (1) a central processing unit including a processor and associated with a memory; and (2) a GPU having at least one fixed function graphics pipeline, the CPU configured to send work to the fixed function graphics pipeline from the application for processing, the fixed function graphics pipeline including a programmable shader stage configured to initiate preemption of the processing of the work along the fixed function graphics pipeline in response to determining occurrence of a pipeline exception.

### BRIEF DESCRIPTION

Reference is now made to the following descriptions taken in conjunction with the accompanying drawings, in which:

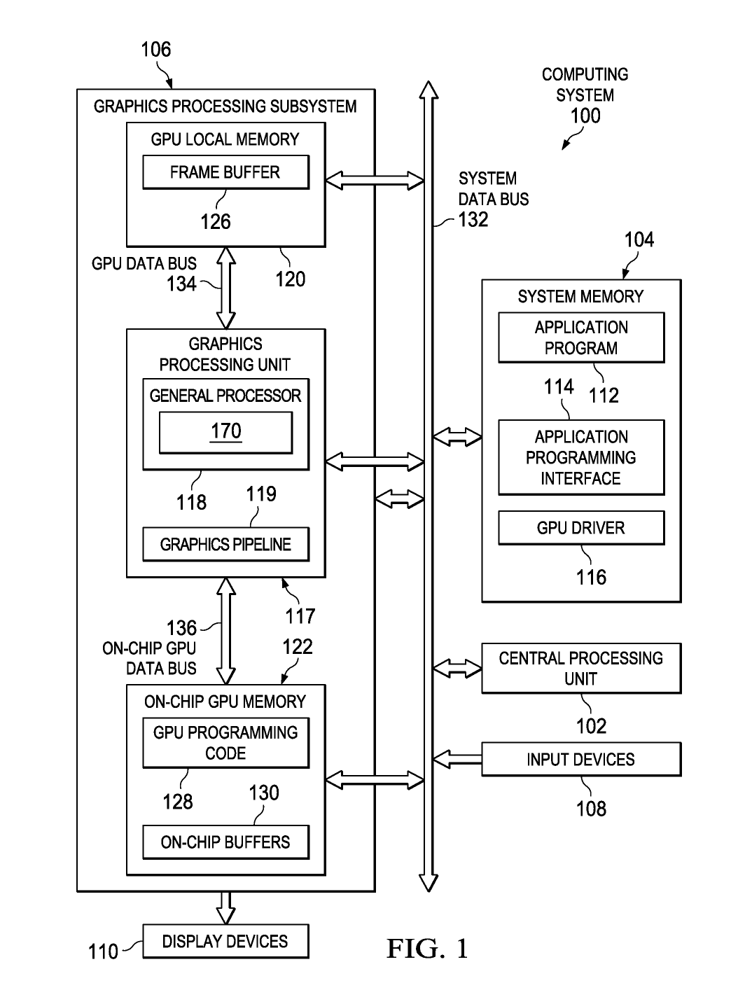

FIG. 1 is a block diagram of an embodiment of a computing system in which one or more aspects of the disclosure may be implemented;

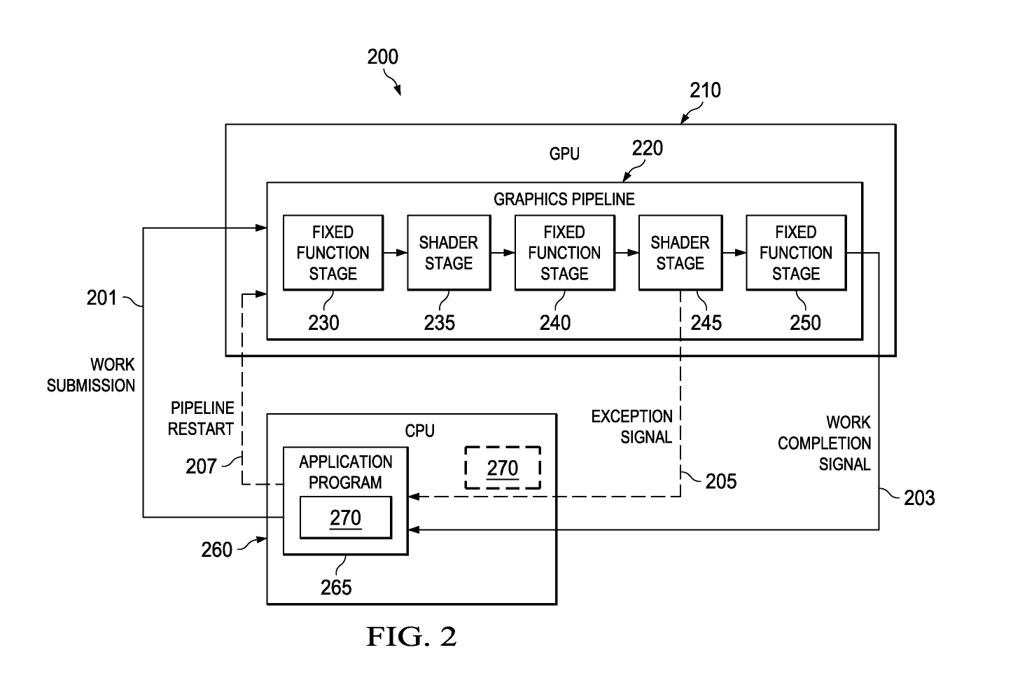

FIG. 2 illustrates a block diagram of an embodiment of a GPU computing system constructed according to the principles of the disclosure; and

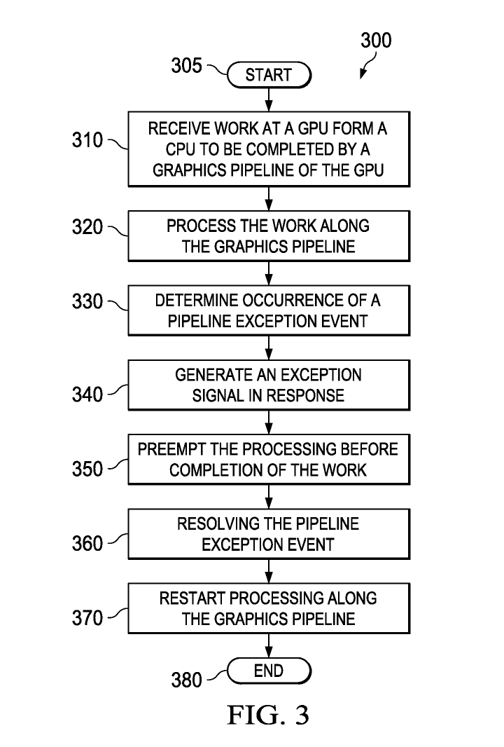

FIG. 3 illustrates a flow diagram of a method of operating a graphics pipeline carried out according to the principles of the disclosure.

### DETAILED DESCRIPTION

The work or work commands received by the GPU from the CPU usually include data for processing by the GPU. The fixed function pipeline of the GPU is efficient at processing a regular stream of data. The GPU, however, is not typically equipped to perform all functions needed in processing the data. This creates a problem when a CPU generates instructions and/or data for the GPU to process (i.e., generates work) but fails to fully equip the GPU to perform the work. For example, the CPU sends work to GPU to complete and allocates memory for the GPU to use in completing the work. A problem arises when sufficient memory has not been allocated by the CPU for the GPU to complete the work and the GPU needs to allocate additional memory. A fixed function pipeline is not efficiently configured to handle infrequent exceptional events, such as, allocating memory when buffers become full or when resources are missing that are needed to perform the work. These events can be better handled using the CPU or GPU's compute mode. A compute mode allows the GPU to run general-purpose programs written in CUDA, OpenCL, or similar languages that are not bound to the limitations of the GPU's graphics pipeline.

As such, the disclosure provides a graphics pipeline wherein processing is stopped and control is relinquished before completion of the work when a pipeline exception is detected. A programmable shader stage of a graphics pipeline is configured to determine occurrence of a pipeline exception during execution of the graphics pipeline, initiate preempting the execution in response to determining the occurrence and initiate resolving the pipeline exception before execution is restarted. A programmable shader stage or “programmable shader” is a stage of the graphics pipeline that typically includes a unified grid of processors that can be programmed to perform fixed function tasks. Examples of shader stages, fixed function or programmable, include a pixel shader, a vertex shader, a geometry shader, etc.

A pipeline exception is the absence of a condition, either a present condition or a recognized future condition, which is needed by the graphics pipeline to complete the assigned work. The condition can be, for example, a resource or data that is needed or will be needed.

In some embodiments, the disclosed graphics pipeline generates an exception signal in response to detecting the pipeline exception to at least initiate halting the graphics pipeline processing and resolving the pipeline exception. In one embodiment, the exception signal can be declared in a programmable shader stage of the graphics pipeline like other output attributes of the programmable shader stage. As noted in some embodiments, if the exception signal output attribute is set at the end of a programmable shader stage, then pipeline execution is preempted, in-flight data is stored, and an exception handler grid is launched or the CPU is notified. The exception handler grid is a computing grid of a processor of a GPU that is configured to operate as an exception handler and resolve identified pipeline exceptions. An exception handler includes the necessary logic to receive an exception signal, determine the condition needed by the graphics pipeline, provide the needed condition, and return control back to the graphics pipeline to continue processing. The exception handler can resolve the cause of the exception and restart the pipeline at the end of the programmable shader stage that triggered the exception. As disclosed herein, an exception handler can be implemented in a general processor of the GPU, in the CPU or in an applications program associated with the CPU.

In some embodiments, an exception handler is also configured to halt processing along the graphics pipeline. The exception handler can employ a general processor of the GPU or a CPU to halt the processing. In some embodiments, existing mechanisms of the GPU or the CPU can be used to halt processing. For example, a core assignor or a hardware thread scheduler of a GPU can be used to halt the processing. An example of a hardware thread scheduler is “Fermi's GigaThread Hardware Thread Scheduler (HTS)” available on a Fermi based GPU from Nvidia Corporation of Santa Clara, Calif. On the CPU, a graphics pre-emption mechanism can be used that halts processing on the graphics pipeline in response to, for example, receiving the exception signal.

Upon halting a processing pipeline, all work in flight after the triggering pipeline stage is drained, the state in and before the current stage, is saved. Thus, unlike regular pre-emption in graphics pipelines, any in-flight primitive is rendered to completion. This ensures that at least in some embodiments all frame buffers, such as frame buffer 126 in FIG. 1, are in a known good state after the exception and exceptions are “precise.”

In one embodiment, the graphics pipeline transfers control back to the CPU until the pipeline exception is resolved. In another embodiment, the graphics pipeline transfers control to a processor of the GPU until the pipeline exception is resolved.

In some graphics pipelines disclosed herein, identifying pipeline exceptions is limited to a single programmable shader stage to simplify the implementation. In other embodiments, multiple programmable shader stages can be configured to identify a pipeline exception and generate an exception signal. Exception signals are precise. As such, in some embodiments all work launched before the triggering programmable shader stage is run to completion, such that all buffers of the GPU are in a known good state when the exception handler runs. The disclosure therefore provides a controlled preemption of a graphics pipeline wherein control is transferred away from the graphics pipeline unit until a pipeline exception is resolved.

Before describing various embodiments of the novel method and mechanism, a computing system within which the mechanism may be embodied or the method carried out will be described.

FIG. 1 is a block diagram of one embodiment of a computing system 100 in which one or more aspects of the invention may be implemented. The computing system 100 includes a system data bus 132, a central CPU 102, input devices 108, a system memory 104, a graphics processing subsystem 106 including a graphics processing unit (GPU) 117, and display devices 110. In alternate embodiments, the CPU 102, portions of the graphics processing subsystem 106, the system data bus 132, or any combination thereof, may be integrated into a single processing unit. Further, the functionality of the graphics processing subsystem 106 may be included in a chipset or in some other type of special purpose processing unit or co-processor.

As shown, the system data bus 132 connects the CPU 102, the input devices 108, the system memory 104, and the graphics processing subsystem 106. In alternate embodiments, the system memory 100 may connect directly to the CPU 102. The CPU 102 receives user input from the input devices 108, executes programming instructions stored in the system memory 104, operates on data stored in the system memory 104, sends instructions and/or data (i.e., work or tasks to complete) to a graphics processing unit 117 to complete and configures needed portions of the graphics processing system 106 for the GPU 117 to complete the work. The system memory 104 typically includes dynamic random access memory (DRAM) used to store programming instructions and data for processing by the CPU 102 and the graphics processing subsystem 106. The GPU 117 receives the transmitted work from the CPU 102 and processes the work. In this embodiment, the GPU 117 completes the work in order to render and display graphics images on the display devices 110. In other embodiments, the graphics processing subsystem 106 can be used for non-graphics processing. A graphics pipeline 119 of the GPU 117 is employed for processing the work.

As also shown, the system memory 104 includes an application program 112, an application programming interface (API) 114, and a graphics processing unit (GPU) driver 116. The application program 112 generates calls to the API 114 in order to produce a desired set of results, typically in the form of a sequence of graphics images.

The graphics processing subsystem 106 includes the GPU 117, an on-chip GPU memory 122, an on-chip GPU data bus 136, a GPU local memory 120, and a GPU data bus 134. The GPU 117 is configured to communicate with the on-chip GPU memory 122 via the on-chip GPU data bus 136 and with the GPU local memory 120 via the GPU data bus 134. As noted above, the GPU 117 can receive instructions from the CPU 102, process the instructions in order to render graphics data and images, and store these images in the GPU local memory 120. Subsequently, the GPU 117 may display certain graphics images stored in the GPU local memory 120 on the display devices 110.

The GPU 117 includes a processor 118 and the graphics pipeline 119. The processor 118 is a general purpose processor configured to assist in operating the GPU 117. The processor 118 can include multiple processing grids that can be programmed for specific functions. The processor 118 includes an exception handler 170 configured to receive an exception signal from the graphics pipeline 119 and in response thereof resolve the pipeline exception and thereafter restart the execution of the graphics pipeline 119. As such, the processor 118, or the exception handler 170 implemented therein, is configured to perform the preempting and the restarting.

The graphics pipeline 119 includes fixed function stages and programmable shader stages. The fixed function stages can be typical hardware stages included in a fixed function pipeline of a GPU. The programmable shader stages can be streaming multiprocessors. Each of the streaming multiprocessors is capable of executing a relatively large number of threads concurrently. Advantageously, each of the streaming multiprocessors can be programmed to execute processing tasks relating to a wide variety of applications, including but not limited to linear and nonlinear data transforms, filtering of video and/or audio data, modeling operations (e.g., applying of physics to determine position, velocity, and other attributes of objects), and so on.

Unlike conventional programmable shader stages, the graphics pipeline 119 includes at least one programmable shader stage that is configured to determine occurrence of a pipeline exception during execution of the graphics pipeline, initiate preempting the execution in response to determining the occurrence and initiate resolving the pipeline exception before restarting the execution. More detail of programmable shader stages is discussed below with respect to FIG. 2.

The GPU 117 may be provided with any amount of on-chip GPU memory 122 and GPU local memory 120, including none, and may use on-chip GPU memory 122, GPU local memory 120, and system memory 104 in any combination for memory operations. The CPU 102 can allocate portions of these memories for the GPU 117 to execute work.

The on-chip GPU memory 122 is configured to include GPU programming code 128 and on-chip buffers 130. The GPU programming 128 may be transmitted from the GPU driver 116 to the on-chip GPU memory 122 via the system data bus 132.

The GPU local memory 120 typically includes less expensive off-chip dynamic random access memory (DRAM) and is also used to store data and programming used by the GPU 117. As shown, the GPU local memory 120 includes a frame buffer 126. The frame buffer 126 stores data for at least one two-dimensional surface that may be used to drive the display devices 110. Furthermore, the frame buffer 126 may include more than one two-dimensional surface so that the GPU 117 can render to one two-dimensional surface while a second two-dimensional surface is used to drive the display devices 110.

The display devices 110 are one or more output devices capable of emitting a visual image corresponding to an input data signal. For example, a display device may be built using a cathode ray tube (CRT) monitor, a liquid crystal display, or any other suitable display system. The input data signals to the display devices 110 are typically generated by scanning out the contents of one or more frames of image data that is stored in the frame buffer 126.

Having described a computing system within which the circuit and method for identifying pipeline exception cases in a graphics pipeline may be embodied or carried out, various embodiments of the circuit and method will be described.

FIG. 2 illustrates a block diagram of an embodiment of a GPU computing system 200 constructed according to the principles of the disclosure. The GPU computing system 200 includes a GPU 210 and a CPU 260. The GPU 210 includes a graphics pipeline 220 having fixed function stages 230, 240, 250, and programmable shader stages 235, 245. In one embodiment, the graphics pipeline 220 corresponds to the graphics pipeline 119 of FIG. 1 and the CPU 260 corresponds to the CPU 102 with a memory, such as the system memory 104, of FIG. 1.

A traditional GPU computing system has limited control transfer between a CPU and a GPU. These controls are represented in FIG. 2 by the solid lines for “Work Submission” 201 and “Work Completion Signal” 203. The solid lines represent the CPU 260 submitting batches of work, Work Submission 201, to the GPU 210 and the GPU 210 responding with a completion notice, Work Completion Signal 203, to the CPU 260 when the work is completed in its entirety. The novel GPU computing system 200 adds another method of control transfer represented by the dashed lines; “Exception Signal” 205 and “Pipeline Restart” 207. The GPU 210 can signal the Exception Signal 205 from a programmable shader stage, such as programmable shader stage 245, and hand control to the CPU 260 before all work is completed. The CPU 260 can later restart the graphic pipeline 220 via the Pipeline Restart 207 and run the original work to completion.

The fixed function stages 230, 240, 250, and the programmable shader stages 225, 235, are configured to perform a designated function along the graphics pipeline 220. The fixed function stages 230, 240, 250, are implemented in hardware and are configured to perform a single dedicated function. The fixed function stages 230, 240 and 250 are conventional hardware implemented stages employed in traditional fixed function graphics pipelines. The programmable shader stages 235, 245, are processor modules that can be programmed to perform specific functions. In one embodiment, the programmable shader stages 235, 245, are implemented on special purpose processors that are well suited for highly parallel code and ill-suited for scalar code.

Programmable shader stage 245 is configured to determine occurrence of a pipeline exception during execution of the graphics pipeline, initiate preempting the execution in response to determining the occurrence and initiate resolving the pipeline exception before restarting the execution. In one embodiment, the programmable shader stage 245 is configured to generate an exception signal to initiate the preempting and the resolving. The exception signal can be an output attribute of the programmable shader stage. Thus, unlike conventional programmable shader stages, the programmable shader stage 245 is configured to recognize when a pipeline exception occurs and transfer control away from the graphics pipeline until the pipeline exception is resolved. In some embodiments, the programmable shader stage 235 is also programmed to determine occurrence of a pipeline exception.

The CPU 260 includes a memory and a processor (not illustrated in FIG. 2) and is configured to generate work and send the work to the GPU 210 for processing. The memory and processor can be conventional components typically employed in a CPU. The CPU 260 also includes an application program 265 that includes a series of operating instructions that direct the operation of a processor when initiated. The application program 265 can be stored on the memory of the CPU 260. The operating instruction can generate calls to an API in order to produce a desired set of results. In some embodiments, the desired set of results is in the form of a sequence of graphics images.

The application program 265 includes an exception handler 270. The exception handler 270 is configured to resolve pipeline exceptions. In one embodiment the exception handler 270 is implemented as part of the application program 265 stored on a memory of or associated with the CPU 260. In another embodiment, the exception handler 270 is implemented as part of the CPU 260 (as represented by the dashed box). In one embodiment, the exception handler 270 is implemented in the CPU 260 and employs a graphics pre-emption mechanism. As such, the exception signal is received by the graphics pre-emption mechanism that then stops the GPU from processing.

In one embodiment, a pipeline exception as disclosed herein is employed to handle fixed size memory resources. For example, algorithms for correctly rendering partially transparent objects, such as an Order Independent Transparency (OIT) algorithm, are often based on storing linked list of layers per pixel and have to pre-allocate a pool to fit the worst case number of layers in a scene or run a prepass to size the pool. With support for pipeline exceptions, a geometry shader, implemented for example on the programmable shader stage 245, can determine if there are enough entries left in the pool to render the current primitive. If not, the geometry shader can trigger an exception signal.

The exception handler 270 can then either allocate more memory or free up pool entries by selectively merging layers. Once sufficient additional memory has been added to the pool, it can restart the graphics pipeline 220.

In another embodiment, the pipeline exception can be used with a hybrid raster/ray-tracing renderer. A raster stage, such as a raster stage implemented on programmable shader stage 235, would use a fixed function stage, such as fixed function stage 230, to render a scene and record ray-launches in a buffer. Once the buffer is sufficiently full, the raster stage can launch a compute grid via the exception handler 270 to process the buffer. An exception signal similar to exception signal 205, can be employed to initiate the compute grid and resolve the pipeline exception. After the buffer is processed, the raster stage is restarted by the exception handler 270. The exception handler 170 of FIG. 1 can also be used in these embodiments instead of the exception handler 270.

FIG. 3 illustrates a flow diagram of a method 300 of operating a graphics pipeline carried out according to the principles of the disclosure. The graphics pipeline can be the graphics pipeline 119 of FIG. 1 or the graphics pipeline 220 of FIG. 2. The method 300 begins in a step 305.

In a step 310, work from a CPU is received at a graphics pipeline that is to be completed by the graphics pipeline. The work can be generated from an application program associated with the CPU.

The graphics pipeline processes the work in a step 320. As such, the various stages of the graphics pipeline perform their designated function on data received from the CPU.

In a step 330, occurrence of a pipeline exception is determined. In one embodiment, a programmable shader stage of the graphics pipeline determines if a pipeline exception has occurred. A pipeline exception is a pre-defined condition associated with executing a portion of the work designated for the programmable shader stage of the graphics pipeline. The pipeline exception can be, for example, a missing resource, a lack of memory space, missing data, etc.

An exception signal is generated in a step 340 in response to determining the occurrence of the pipeline exception. The programmable shader stage can also be configured to generate the exception signal. In one embodiment, the exception signal is an output attribute that is defined by the programmable shader stage. In some embodiments, the exception signal can be used to transfer control of the graphics pipeline to the CPU.

In a step 350, processing along the graphics pipeline is preempted before completion of the work. Preempting of the graphics pipeline is performed in response to determining the occurrence of a pipeline exception. A processor of the GPU can preempt the processing. Preempting occurs before the pipeline exception is resolved, for example, in order to have known states in buffers of the pipeline. In some embodiments, preempting always occurs before the next step that is directed to resolving the pipeline exception.

The pipeline exception is resolved in a step 360. In one embodiment, an exception handler resolves the pipeline exception. In some embodiments, the exception handler is implemented within a processor of the GPU. In other embodiments, the exception handler is implemented within the CPU or an application program associated with the CPU.

After resolving the pipeline exception, the graphics pipeline is restarted in a step 370. The method 300 then continues to a step 380 and ends.

While the method disclosed herein has been described and shown with reference to particular steps performed in a particular order, it will be understood that these steps may be combined, subdivided, or reordered to form an equivalent method without departing from the teachings of the present disclosure. Accordingly, unless specifically indicated herein, the order or the grouping of the steps is not a limitation of the present disclosure.

The above-described apparatuses and methods or at least a portion thereof may be embodied in or performed by various, such as conventional, digital data processors or computers, wherein the computers are programmed or store executable programs of sequences of software instructions to perform one or more of the steps of the methods, e.g., steps of the method of FIG. 3. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods, e.g., one or more of the steps of the method of FIG. 3, or functions of the apparatuses described herein, e.g., an exception handler. As noted above, a programmable shader stage can be implemented on a special purpose processor that is well suited for highly parallel code.

Certain embodiments of the invention further relate to computer storage products with a non-transitory computer-readable medium that have program code thereon for performing various computer-implemented operations that embody the apparatuses, the systems or carry out the steps of the methods set forth herein. For example, an exception handler can be implemented as such a computer storage product. Non-transitory used herein refers to all computer-readable media except for transitory, propagating signals. Examples of non-transitory computer-readable media include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A graphics processing unit, comprising:
a processor configured to assist in operating said graphics processing unit; and
a graphics pipeline coupled to said processor and including a programmable shader stage, said programmable shader stage configured to determine occurrence of a pipeline exception during execution of said graphics pipeline, initiate preempting said execution in response to determining said occurrence and initiate resolving said pipeline exception before execution is restarted.

2. The graphics processing unit as recited in claim 1 wherein said programmable shader stage is configured to generate an exception signal to initiate said preempting and said resolving.

3. The graphics processing unit as recited in claim 2 wherein said exception signal is an output attribute of said programmable shader stage.

4. The graphics processing unit as recited in claim 2 wherein said processor includes an exception handler configured to receive said exception signal and in response thereof resolve said pipeline exception and thereafter restart said execution of said graphics pipeline.

5. The graphics processing unit as recited in claim 1 wherein said pipeline exception is one of multiple pipeline exceptions defined in said programmable shader stage.

6. The graphics processing unit as recited in claim 1 wherein said processor is configured to perform said preempting and said restarting.

7. The graphics processing unit as recited in claim 1 wherein said preempting includes completing in-flight primitives of said graphics pipeline to completion.

8. A method of operating a graphics pipeline of a graphics processing unit, comprising:
receiving work at said graphics processing unit from a central processing unit associated therewith to be completed by said graphics pipeline;
processing said work along said graphics pipeline;
preempting said processing before completion of said work when determining occurrence of a pipeline exception;
resolving said pipeline exception; and
restarting said processing.

9. The method as recited in claim 8 further comprising generating an exception signal when determining said occurrence of said pipeline exception.

10. The method as recited in claim 9 wherein said generating an exception signal is performed by a programmable shader stage of said graphics pipeline.

11. The method as recited in claim 8 wherein said pipeline exception is a pre-defined condition associated with executing a portion of said work designated for a programmable shader stage of said graphics pipeline.

12. The method as recited in claim 8 further comprising transferring control of said graphics pipeline to said central processing unit based on said occurrence.

13. The method as recited in claim 8 wherein said preempting occurs before said resolving.

14. The method as recited in claim 8 wherein said graphics processing unit includes an exception handler that performs said resolving.

15. A GPU computing system, comprising:
a central processing unit including a processor and associated with a memory; and
a GPU having at least one fixed function graphics pipeline, said CPU configured to send work to said fixed function graphics pipeline from said application for processing, said fixed function graphics pipeline including a programmable shader stage configured to initiate preemption of said processing of said work along said fixed function graphics pipeline in response to determining occurrence of a pipeline exception.

16. The GPU computing system as recited in claim 15 wherein said graphics processing unit further includes a processor having an exception handler configured to resolve said pipeline exception.

17. The GPU computing system as recited in claim 15 wherein said programmable shader stage is further configured to determine said occurrence of said pipeline exception during said processing along said graphics pipeline and initiate resolving said pipeline exception before restarting said processing.

18. The GPU computing system as recited in claim 17 wherein said programmable shader stage is configured to generate an exception signal to initiate said preempting and said resolving, wherein said exception signal is an output attribute of said programmable shader stage.

19. The GPU computing system as recited in claim 15 wherein said CPU is configured to receive control of said graphics pipeline after said programmable shader determines said occurrence.

20. The GPU computing system as recited in claim 15 wherein said memory is configured to include an application program stored therein that includes an exception handler to resolve said pipeline exception.
